(19) United States
(12) Patent Application Publication
(10) Pub. No.: US 2017/0331606 A1
(43) Pub. Date: Nov. 16, 2017

(54) Sounding Reference Signal Design for LAA

(71) Applicant: MEDIATEK INC., Hsinchu (TW)

(72) Inventors: Bo-Si Chen, Keelung City (TW); Chien-Chang Li, Penghu County (TW); Weidong Yang, San Diego, CA (US); Yih-Shen Chen, Hsinchu City (TW)

(21) Appl. No.: 15/593,091

(22) Filed: May 11, 2017

Related U.S. Application Data
(60) Provisional application No. 62/336,536, filed on May 13, 2016.

(51) Int. Cl. H04L 5/00; H04W 72/04; H04W 76/04

(52) U.S. Cl. CPC H04L 5/0048; H04W 76/046; H04L 5/0007; H04W 72/0413

(57) ABSTRACT

A method of supporting uplink aperiodic sounding reference signal (SRS) transmission in licensed assisted access (LAA) wireless communication networks is provided. In one novel aspect, a base station can configure each UE with a group ID by RRC signaling, and then use DCI to signal the group to transmit SRS in the corresponding SC-FDMA symbol. A new cell specific RNTI is introduced for the group DCI. In a first embodiment, the DCI comprises a list of group IDs, each indicating a group ID for SRS transmission in the corresponding SC-FDMA symbol in the UpPTS. In a second embodiment, the DCI comprises a number of SC-FDMA symbols in the UpPTS and an offset value of the group ID for SRS transmission. The proposed method can trigger different groups of UEs in multiple SC-FDMA symbols in a flexible way.

### CROSS REFERENCE TO RELATED APPLICATIONS

This application claims priority under 35 U.S.C. §119 from U.S. Provisional Application No. 62/336,536, entitled “SRS design for LAA,” filed on May 13, 2016; the subject matter of which is incorporated herein by reference.

### TECHNICAL FIELD

The disclosed embodiments relate generally to wireless network communications, and, more particularly, to sounding reference signal design in License-Assisted Access (LAA) systems.

### BACKGROUND

Orthogonal Frequency-Division Multiple Access (OFDMA) is a multi-user version of the Orthogonal Frequency-Division Multiplexing (OFDM) digital modulation technology. In wireless OFDMA systems, however, multipath is an undesirable common propagation phenomenon that results in radio signals reaching the receiving antenna by two or more paths. Signal variations in amplitude or phase resulted from multipath are also referred as channel response. Transmission techniques, in which a transmitter makes use of the channel response between the transmitter and a receiver, are called close-loop transmission techniques. In multiple-input multiple-output (MIMO) applications, close-loop transmission techniques are much more robust as compared with open-loop MIMO techniques.

One method of providing channel information to the transmitter is via the use of an uplink (UL) sounding channel. Channel sounding is a signaling mechanism where a mobile station (also referred to as a user equipment (UE)) transmits sounding reference signals (SRS) on an uplink channel to enable a base station (also referred to as an eNodeB) to estimate the UL channel response. Channel sounding assumes the reciprocity of uplink and downlink channels, which is generally true in Time Division Duplexing (TDD) systems. Because the frequency bandwidth of the UL transmission encompasses the frequency bandwidth of the DL transmission in TDD systems, UL channel sounding can enable close-loop SU/MU-MIMO in downlink transmission. For example, the eNodeB can perform non-codebook based downlink beamforming based on channel state information (CSI) measured via SRS. UL channel sounding can also enable UL close-loop MIMO transmission in both TDD and Frequency Division Duplexing (FDD) systems. For example, the eNodeB can perform codebook based uplink beamforming by choosing the best precoding weights (vectors/matrices) (e.g., select the best PMI from the codebook) to be used for the UE based on CSI measured by SRS, such that the UE can perform close-loop SU/MU-MIMO in UL transmission. In TDD system, UL channel sounding can also be used for frequency selective scheduling, where the eNodeB schedules the UE to its best frequency band in both downlink and uplink transmissions.

In 3GPP LTE-Advanced (LTE-A) wireless communication systems, two types of SRS are defined. A first type of Periodic SRS (p-SRS) is used for obtaining long-term channel information. The periodicity of p-SRS is in general long (up to 320 ms) to reduce overhead. The p-SRS parameters are configured by higher layer radio resource control (RRC), so configuration time is long (e.g., 15-20 ms) and flexibility is low. For uplink MIMO, p-SRS resource is highly demanded for close-loop spatial multiplexing, especially when the number of UEs becomes large. A second type of a-periodic SRS (ap-SRS) is triggered either by uplink grant or downlink scheduler via physical downlink control channel (PDCCH). Once triggered, the UE transmits a sounding sequence in a pre-defined location for one-time transmission. Ap-SRS supports multi-antenna sounding for uplink MIMO. Ap-SRS is much more flexible than p-SRS.

Third generation partnership project (3GPP) and Long Term Evolution (LTE) mobile telecommunication systems provide high data rate, lower latency and improved system performances. With the rapid development of “Internet of Things” (IOT) and other new user equipment (UE), the demand for supporting machine communications increase exponentially. To meet the demand of this exponential increase in communications, additional spectrum (i.e. radio frequency spectrum) is needed. The amount of licensed spectrum is limited. Therefore, communications providers need to look to unlicensed spectrum to meet the exponential increase in communication demand. One suggested solution is to use a combination of licensed spectrum and unlicensed spectrum. This solution is referred to as “Licensed Assisted Access” or “LAA”. In LAA, an established communication protocol such as LTE can be used over the licensed spectrum to provide a first communication link, and LTE can also be used over the unlicensed spectrum to provide a second communication link. Furthermore, while LAA only utilizes the unlicensed spectrum to boost downlink through a process of carrier aggregation, enhanced LAA (eLAA) allows uplink streams to take advantage of the unlicensed bands as well.

The legacy method to trigger a-periodic SRS in LAA is not proper, because the downlink control information (DCI) to trigger SRS always binds with an uplink grant or a downlink scheduling. Moreover, the legacy method will make UE transmit in the same single carrier FDMA (SC-FDMA) symbol configured by upper layer in uplink pilot time slot (UpPTS). It is not flexible in LAA, since the number of symbols in UpPTS would be variable with the number of symbols in DL ending partial subframe. The UEs configured to transmit in the same SC-FDMA symbol, it is possible that some UEs will have fewer chances to transmit SRS than other UEs. In Rel-13, there could be up to 6 symbols in UpPTS, and 4 comb number and 12 cyclic shifts could be selected. UE-specific DCI is not an efficient method to trigger different groups of UEs in SC-FDMA symbols in a flexible way. A solution is sought.

### SUMMARY

A method of supporting uplink aperiodic sounding reference signal (SRS) transmission in licensed assisted access (LAA) wireless communication networks is provided. In one novel aspect, a base station can configure each UE with a group ID by RRC signaling, and then use DCI to signal the group to transmit SRS in the corresponding SC-FDMA symbol. A new cell specific RNTI is introduced for the group DCI. In a first embodiment, the DCI comprises a list of group IDs, each indicating a group ID for SRS transmission in the corresponding SC-FDMA symbol in the UpPTS. In a second embodiment, the DCI comprises a number of SC-FDMA symbols in the UpPTS and an offset value of the group ID for SRS transmission. The proposed method can trigger different groups of UEs in multiple SC-FDMA symbols in a flexible way.

In one embodiment, a user equipment (UE) receives a radio resource control (RRC) signaling in a license assisted access (LAA) wireless communication network. The RRC signaling configures a group ID for the UE. The UE receives a physical layer signaling and thereby detecting a triggering condition for aperiodic sounding transmission in an indicated OFDM symbol. The triggering condition is associated with the configured group ID of the UE. The UE selects UE-specific sounding reference signal (SRS) parameters based on the RRC signaling. The UE transmits an aperiodic SRS using the UE-specific SRS parameters in the indicated OFDM symbol based on the physical layer signaling.

In another embodiment, a base station transmits a radio resource control (RRC) signaling in a license assisted access (LAA) wireless communication network. The RRC signaling configures a group ID for a user equipment (UE). The base station transmits a physical layer signaling to the UE for triggering aperiodic sounding transmission in an indicated OFDM symbol. The physical layer signaling indicates a triggering condition associated with the configured group ID of the UE. The base station provides UE-specific sounding reference signal (SRS) parameters via the RRC signaling. The base station receives an aperiodic SRS applied with the UE-specific SRS parameters in the indicated OFDM symbol from the UE.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates uplink channel sounding in licensed assisted access (LAA) wireless communication systems in accordance with one novel aspect.

FIG. 2 illustrates simplified block diagrams of a user equipment and a base station that carry out embodiments of the present invention.

FIG. 3 illustrates a method of uplink aperiodic sounding reference signal (SRS) transmission in accordance with one novel aspect.

FIG. 4 illustrates a first embodiment of DCI format and triggering condition for uplink aperiodic SRS transmission.

FIG. 5 illustrates a second embodiment of DCI format and triggering condition for uplink aperiodic SRS transmission.

FIG. 6 is a flow chart of a method of uplink aperiodic SRS transmission from UE perspective in LAA systems in accordance with one novel aspect.

FIG. 7 is a flow chart of a method of uplink aperiodic SRS transmission from BS perspective in LAA systems in accordance with one novel aspect.

### DETAILED DESCRIPTION

Reference will now be made in detail to some embodiments of the invention, examples of which are illustrated in the accompanying drawings.

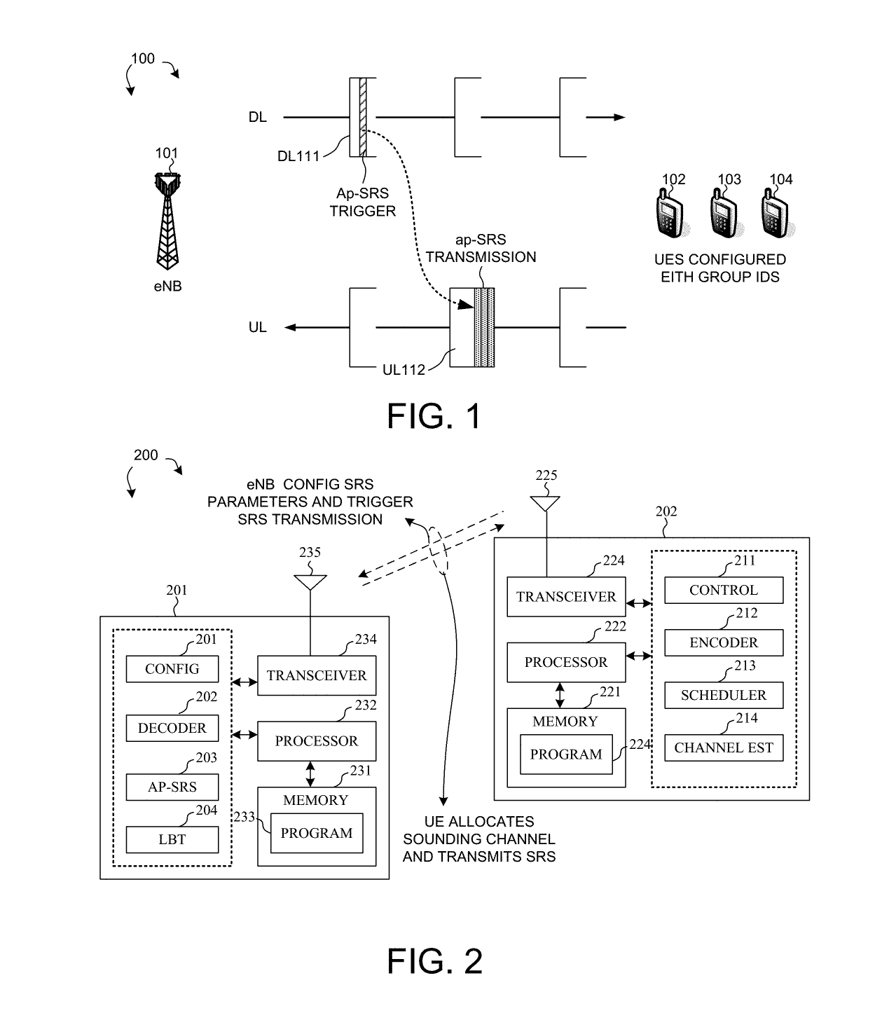

FIG. 1 illustrates uplink channel sounding in a licensed assisted access (LAA) LTE wireless communication system 100 in accordance with one novel aspect. In wireless communication system 100, a base station (also referred to as an eNodeB or eNB, e.g., eNB 101) and a plurality of mobile stations (also referred to as user equipments (UEs), e.g., UE 102, UE 103, and UE 104) communicate with each other by sending and receiving data carried in a series of frames according to a predefined frame structure. Each frame comprises a number of downlink (DL) subframes for the eNB to transmit data to the UE, and a number of uplink (UL) subframes for the UE to transmit data to the eNB. Uplink channel sounding is a signaling mechanism to facilitate various close-loop transmission techniques such as DL/UL beamforming and frequency selective scheduling. For uplink channel sounding, the eNB configures sounding reference signal (SRS) parameters and allocates SRS resource in a previous DL subframe (e.g., subframe DL 111), and the UE transmits a sounding signal in a subsequent UL subframe (e.g., UL 112), also referred to as uplink pilot time slot (UpPTS), to enable the eNB 101 to estimate uplink channel response.

In 3GPP LTE-A systems, two types of SRS are defined for uplink channel sounding. A first type of Periodic SRS (p-SRS) is used for obtaining long-term channel response information. The periodicity of p-SRS is in general long (up to 320 ms). The p-SRS parameters are configured and triggered by higher layer radio resource control (RRC), so configuration time is long (e.g., 15-20 ms delay) and flexibility is low. A second type of a-periodic SRS (ap-SRS) is also configured via RRC. Ap-SRS, however, is dynamically triggered by an uplink grant or a downlink scheduling from the eNB. Once triggered, the UE transmits a sounding signal to the eNB in a pre-defined location. Ap-SRS is much more flexible than p-SRS and can use residual resource that is not used by p-SRS by multiplexing between ap-SRS and p-SRS.

Legacy method to trigger a-periodic SRS in uplink pilot time slot (UpPTS) in LAA is not proper, because the downlink control information (DCI) to trigger SRS always binds with a physical uplink shared channel (PUSCH) grant or a physical downlink shared channel (PDSCH) scheduling. Moreover, the legacy method will make UE transmit SRS in the same SC-FDMA symbol configured by RRC in UpPTS. It is not flexible in LAA, since the number of symbols in UpPTS would be variable with the number of symbols in DL ending partial subframe. If UE is configured to transmit SRS in the same SC-FDMA symbol, it is possible that the some UEs will have fewer chances to transmit SRS than other UEs. Furthermore, there could be up to six symbols in UpPTS, and four comb number and twelve cyclic shifts could be selected. Therefore, UE-specific DCI is not an efficient method to trigger different groups of UEs in SC-FDMA symbols in a flexible way.

In one novel aspect, the eNB can configure each UE with a group ID by RRC signaling, and then use DCI to signal the group to transmit SRS in the corresponding SC-FDMA symbol. A new cell specific RNTI is introduced for the group DCI. In the example of FIG. 1, eNB 101 first configures UE 102, UE 103, and UE 104 with their group IDs, and then transmits ap-SRS triggering information in an uplink grant in a previous downlink subframe DL 101. Based on the ap-SRS triggering information, UE 102, UE 103, and UE 104 detect a triggering condition in the uplink grant. If the triggering condition is satisfied, e.g., UE 102 detects that its group ID is matched, then UE 102 selects the latest RRC configured UE-specific ap-SRS parameters. Finally, UE 102 transmits an ap-SRS in a subsequent uplink subframe UL 112 by following the selected UE-specific ap-SRS parameters.

FIG. 2 illustrates simplified block diagrams of a user equipment UE 201 and a base station eNB 202 that carry out embodiments of the present invention. LTE-A system 200 comprises a user equipment UE 201 and a base station eNB 202. UE 201 has an antenna array 235 with one or more antennas, which transmit and receive radio signals. An RF transceiver module 234, coupled with the antenna, receives RF signals from antenna array 235, converts them to baseband signals and sends them to processor 232. RF transceiver 234 also converts received baseband signals from processor 232, converts them to RF signals, and sends out to antenna 235. Processor 232 processes the received baseband signals and invokes different functional modules and circuits to perform features in UE 201. Memory 231 stores program instructions and data 233 to control the operations of UE 201.

Similarly, base station 202 may have an antenna array 225 with one or more antennas, which transmit and receive radio signals. An RF transceiver module 224, coupled with the antenna, receives RF signals from antenna array 225, converts them to baseband signals and sends them to processor 222. RF transceiver 224 also converts received baseband signals from processor 222, converts them to RF signals, and sends out to antenna array 225. Processor 222 processes the received baseband signals and invokes different functional modules and circuits to perform features in base station 202. Memory 221 stores program instructions and data 223 to control the operations of base station 202.

For uplink channel sounding, eNB 202 configures SRS parameters and allocating SRS resource by transmitting encoded signaling information to UE 201 via RRC signaling and via PDCCH. Based on the signaling information, UE 201 decodes the SRS parameters and transmits a sounding signal via an allocated sounding channel to eNB 202 for uplink channel estimation. In one or more exemplary embodiments, the functions described in the uplink sounding procedure may be implemented in hardware, software, firmware, or any combination thereof by the different modules. The functions described above may be implemented together in the same module/circuit, or implemented independently in separate modules/circuits.

For example, at the eNB side, control circuit 211 determines SRS parameters and triggering information, information-encoder 212 prepares and encodes SRS parameter and triggering information, scheduler 213 determines uplink grant and downlink scheduling, and transceiver 224 transmits the information via RRC signaling or via PDCCH. Channel estimation module 214 performs uplink channel estimation based on received SRS. At the UE side, configurator 201 obtains various configuration and parameters from the network for uplink sounding operation. Information-decoder 202 detects and decodes the SRS parameter and triggering information, SRS and UL sounding circuit 203 maps an aperiodic SRS in an allocated sounding channel, and transceiver 234 transmits the aperiodic SRS applied with the SRS parameters upon the SRS triggering condition is satisfied. Listen before talk (LBT) channel access handler 204 ensures that UE 201 does not transmit signals when another unlicensed frequency band eNB/UE is transmitting.

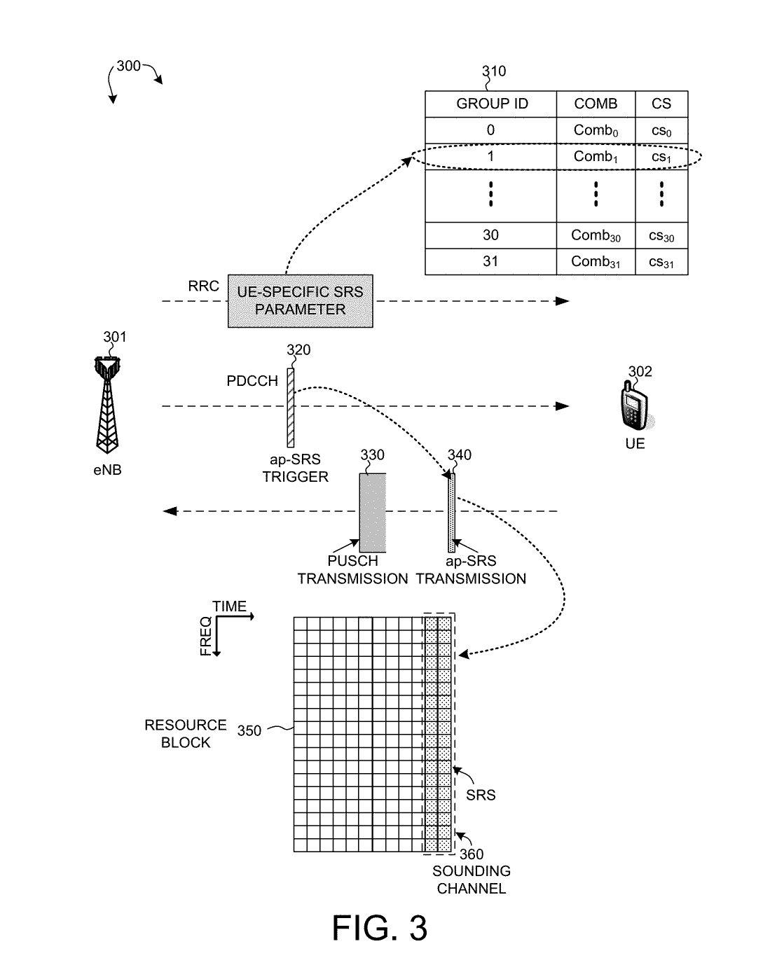

FIG. 3 illustrates a method of uplink aperiodic sounding reference signal (SRS) transmission for license assisted access (LAA) system 300 in accordance with one novel aspect. Traditionally, SRS parameters are configured via RRC. To dynamically trigger ap-SRS transmission, however, the use of higher layer RRC is no longer efficient because of the long latency. Therefore, a faster physical layer signaling method is desirable for triggering ap-SRS transmission, to be combine with RRC signaling for configuring ap-SRS parameters. In one example, ap-SRS parameters may be configured via RRC, and ap-SRS transmission may be triggered via a physical downlink control channel (PDCCH) that provides reasonable flexibility. In accordance with one novel aspect, for LAA system 300, eNB 301 configures UE 302 with one or more group IDs by RRC signaling, and then use PDCCH DCI to signal the group to transmit aperiodic SRS in the corresponding SC-FDMA symbol.

In 3GPP LTE-A systems, for configuring p-SRS or ap-SRS parameters, two types of SRS parameters are defined in 3GPP LTE-A systems. A first type of cell-specific parameters includes SRS bandwidth configuration and SRS subframe configuration. The cell-specific parameters are used to define the overall SRS resource allocated in a cell served by an eNB. A second type of UE-specific parameters includes SRS bandwidth allocation, SRS hopping bandwidth, frequency domain position, SRS duration, number of antenna ports, transmission comb, and cyclic shift (CS). The UE-specific parameters are used to define SRS resource allocation for each individual UE. Because cell-specific SRS parameters of p-SRS can be re-used for ap-SRS, only UE-specific parameters need to be selected for ap-SRS transmission.

For LAA, the UE-specific SRS parameters for each UE should contain transmission comb {0 . . . 3} and cyclic shift (cs0 . . . cs11) as in legacy design. The parameters for frequency domain position and bandwidth are unnecessary, since UE should only transmit wideband SRS. The parameters for transmission timing are also unnecessary, because UE cannot always win the contention in the specific subframe, depending on the LBT procedure. The transmission timing rule thus should be redefined in LAA. For example, the transmission timing rule could be that if group DCI transmits in subframe n, then the triggered UE should transmit in the UpPTS after the DL partial subframe in subframe n+k, k>=4. In addition to the legacy parameters, for group triggering, a group ID should be configured to UE by RRC parameters.

As depicted in Table 310, the RRC parameters for UE-specific SRS contain the following information: transmission comb (0 . . . 3), cyclic shift (cs0 . . . cs11), and group ID. Furthermore, a UE can be configured with a single group ID or multiple group IDs. If a UE is configured with multiple group IDs, it is more flexible to trigger different UEs to transmit SRS. Moreover, if a UE is configured with multiple group IDs, the eNB can configure a UE with different transmission combs and cyclic shifts in different groups. For example, each group ID can be associated with its own transmission comb value and cyclic shift value. If UE 302 is configured with group ID 1, then UE 302 can use transmission Comb₁ and cyclic shift CS₁ for SRS transmission when group 1 is triggered for SRS transmission. Similarly, if UE 302 is also configured with group ID n, then UE 302 can use transmission Combₙ and cyclic shift CSₙ for SRS transmission when group n is triggered for SRS transmission.

To trigger ap-SRS transmission, eNB 301 transmits PDCCH 320 carrying a group DCI with a new DCI format. Upon receiving the group DCI, UE 302 detects any triggering condition and thereby determining whether to trigger ap-SRS transmission 340. Note that the triggering group DCI should not be UE-specific and thus is not binding with uplink grant and PUSCH transmission 330. Since the number of symbols in UpPTS may be variable with the number of symbols in DL ending partial subframes, the DCI should contain information of the number of symbols in UpPTS, e.g., the allocated sounding channel 360. Moreover, to trigger group SRS transmissions in SC-FDMA symbols in UpPTS, DCI should contain information of the group ID corresponding to each SC-FDMA symbols in UpPTS. If the triggering condition is true, then UE 302 selects the UE-specific SRS parameters based on the latest RRC message and its group ID. Finally, in resource block 350 containing the UpPTS, UE 302 maps ap-SRS 340 in sounding channel 360, and then transmits ap-SRS 340 applied with the selected UE-specific parameters.

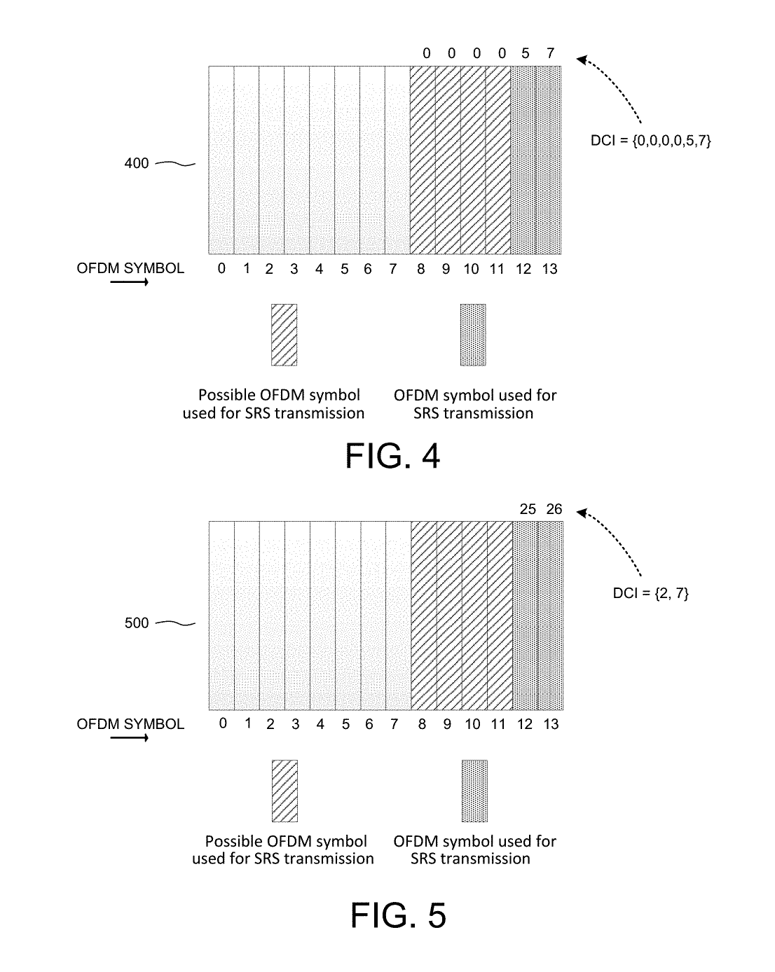

FIG. 4 illustrates a first embodiment of a DCI format and triggering condition for uplink aperiodic SRS transmission. In LTE systems, up to six SC-FDMA symbols in UpPTS for ap-SRS could be supported. In the first embodiment, eNodeB indicates six group IDs in the DCI for SRS transmission, each group ID corresponds to one SC-FDMA symbol. One group ID is reserved for the case that the SC-FDMA symbol could not be used for SRS transmission. As depicted in FIG. 4, subframe 400 comprises 14 symbols, and the last 6 symbols are possible OFDM symbols to be used for SRS transmission. Assume there are 2 SC-FDMA symbols in UpPTS 400, and eNodeB want to indicate group ID 5 and 7 to transmit in the corresponding SC-FDMA symbols. Assume that group ID 0 is reserved for the case that the SC-FDMA symbol could not be used for SRS transmission. Then, the group DCI should contain the sequence of six numbers {0, 0, 0, 0, 5, 7} corresponding to the six SC-FDMA symbols. The first four 0 indicate the first four SC-FDMA symbols cannot be used for SRS transmission, and the following two numbers 5 and 7 indicate which group of UEs to transmit SRS. For example, a UE configured with group ID 5 should transmit SRS in SC-FDMA symbol 12, and a UE configured with group ID 7 should transmit SRS in SC-FDMA symbol 13. Note that in this method, the maximum number of groups should be constrained by the number of bits in DCI. If there are 30 bits in DCI format, then 30/6=5 bits could be used for group IDs. As a result, 32 group IDs could be used and one of them is reserved for the case that the SC-FDMA symbol could not be used.

FIG. 5 illustrates a second embodiment of DCI format and triggering condition for uplink aperiodic SRS transmission. In LTE systems, up to six SC-FDMA symbols in UpPTS for ap-SRS could be supported. In the second embodiment, DCI Indicates the number of SC-FDMA symbols in the UpPTS and an offset value. The group to transmit SRS in symbol i is {(group ID+offset value) % number of groups=i}. As depicted in FIG. 5, subframe 500 comprises 14 symbols, and the last 6 symbols are possible OFDM symbols to be used for SRS transmission. Assume there are total 32 groups, two SC-FDMA symbols in UpPTS (i=0,1), and offset value is set to 7. The group DCI just indicate the number of symbols=2 and offset=7. Then UEs can derive the starting symbols for SRS transmission. In addition, UEs with group ID=25 should transmit in symbol 0 {(25+7)%32=0} in UpPTS, and UEs with group ID=26 should transmit in symbol 1 in UpPTS. Note that in this method, the total number of group should also be signaled by the RRC parameters.

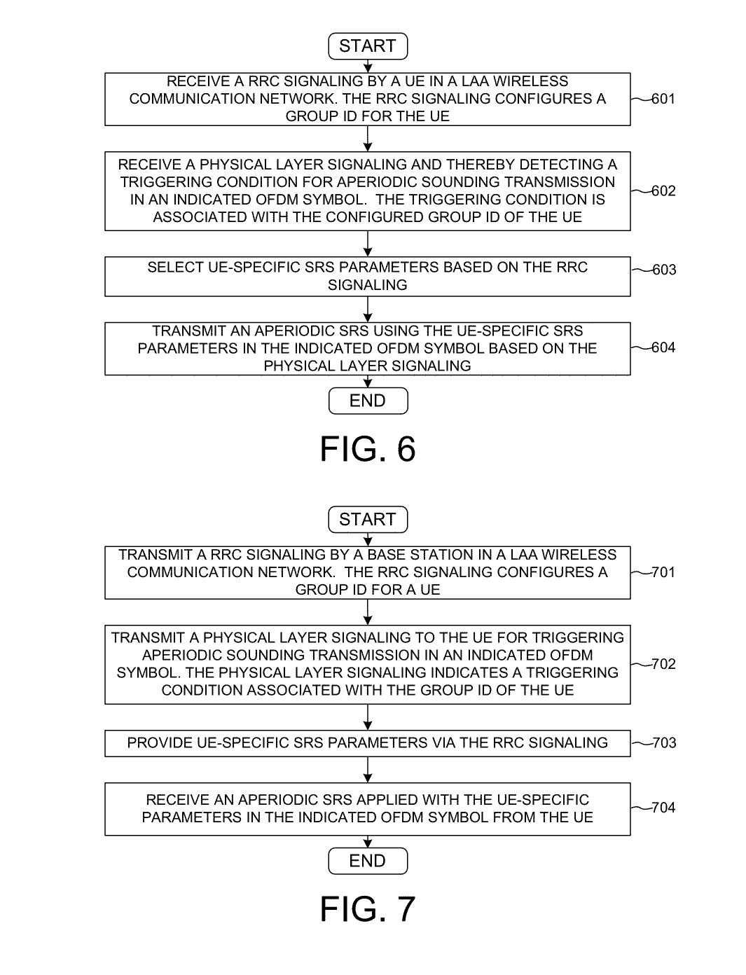

FIG. 6 is a flow chart of a method of uplink aperiodic SRS transmission from UE perspective in LAA systems in accordance with one novel aspect. In step 601, a user equipment (UE) receives a radio resource control (RRC) signaling in a license assisted access (LAA) wireless communication network. The RRC signaling configures a group ID for the UE. In step 602, the UE receives a physical layer signaling and thereby detecting a triggering condition for aperiodic sounding transmission in an indicated OFDM symbol. The triggering condition is associated with the configured group ID of the UE. In step 603, the UE selects UE-specific sounding reference signal (SRS) parameters based on the RRC signaling. In step 604, the UE transmits an aperiodic SRS using the UE-specific SRS parameters in the indicated OFDM symbol based on the physical layer signaling.

FIG. 7 is a flow chart of a method of uplink aperiodic SRS transmission from BS perspective in LAA systems in accordance with one novel aspect. In step 701, a base station transmits a radio resource control (RRC) signaling in a license assisted access (LAA) wireless communication network. The RRC signaling configures a group ID for a user equipment (UE). In step 702, the base station transmits a physical layer signaling to the UE for triggering aperiodic sounding transmission in an indicated OFDM symbol. The physical layer signaling indicates a triggering condition associated with the configured group ID of the UE. In step 703, the base station provides UE-specific sounding reference signal (SRS) parameters via the RRC signaling. In step 704, the base station receives an aperiodic SRS applied with the UE-specific SRS parameters in the indicated OFDM symbol from the UE.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a radio resource control (RRC) signaling by a user equipment (UE) in a license assisted access (LAA) wireless communication network, wherein the RRC signaling configures a group ID for the UE;
receiving a physical layer signaling and thereby detecting a triggering condition for aperiodic sounding transmission in an indicated OFDM symbol, wherein the triggering condition is associated with the configured group ID of the UE;
selecting UE-specific sounding reference signal (SRS) parameters based on the RRC signaling; and
transmitting an aperiodic SRS using the UE-specific SRS parameters in the indicated OFDM symbol based on the physical layer signaling.

2. The method of claim 1, where the UE-specific SRS parameters comprises a transmission comb, a cyclic shift, and the group ID configured by the RRC signaling.

3. The method of claim 1, wherein the physical layer signaling comprises a list of group IDs, wherein the triggering condition is detected by matching the group ID with the list of group IDs.

4. The method of claim 3, wherein each group ID corresponds to an OFDM symbol for SRS transmission.

5. The method of claim 1, wherein the physical layer signaling comprises a number of OFDM symbols for SRS transmission and an offset value.

6. The method of claim 5, wherein the triggering condition is detected by matching the group ID plus the offset value with the number of OFDM symbols.

7. The method of claim 1, wherein the UE is configured with multiple group IDs for aperiodic SRS transmission by the RRC signaling.

8. A user equipment (UE), comprising:
a radio frequency (RF) receiver that receives a radio resource control (RRC) signaling in a license assisted access (LAA) wireless communication network, wherein the RRC signaling configures a group ID for the UE;
a detector that receives a physical layer signaling and thereby detecting a triggering condition for aperiodic sounding transmission in an indicated OFDM symbol, wherein the triggering condition is associated with the configured group ID of the UE;
a sounding circuit that selects UE-specific sounding reference signal (SRS) parameters based on the RRC signaling; and
an RF transmitter that transmits an aperiodic SRS using the UE-specific SRS parameters in the indicated OFDM symbol based on the physical layer signaling.

9. The UE of claim 8, where the UE-specific SRS parameters comprises a transmission comb, a cyclic shift, and the group ID configured by the RRC signaling.

10. The UE of claim 8, wherein the physical layer signaling comprises a list of group IDs, wherein the triggering condition is detected by matching the group ID with the list of group IDs.

11. The UE of claim 10, wherein each group ID corresponds to an OFDM symbol for SRS transmission.

12. The UE of claim 8, wherein the physical layer signaling comprises a number of OFDM symbols for SRS transmission and an offset value.

13. The UE of claim 12, wherein the triggering condition is detected by matching the group ID plus the offset value with the number of OFDM symbols.

14. The UE of claim 8, wherein the UE is configured with multiple group IDs for aperiodic SRS transmission by the RRC signaling.

15. A method, comprising:
transmitting a radio resource control (RRC) signaling by a base station in a license assisted access (LAA) wireless communication network, wherein the RRC signaling configures a group ID for a user equipment (UE);
transmitting a physical layer signaling to the UE for triggering aperiodic sounding transmission in an indicated OFDM symbol, wherein the physical layer signaling indicates a triggering condition associated with the configured group ID of the UE;
providing UE-specific sounding reference signal (SRS) parameters via the RRC signaling; and
receiving an aperiodic SRS applied with the UE-specific SRS parameters in the indicated OFDM symbol from the UE.

16. The method of claim 15, where the UE-specific SRS parameters comprises a transmission comb, a cyclic shift, and the group ID configured by the RRC signaling.

17. The method of claim 15, wherein the physical layer signaling comprises a list of group IDs, wherein the triggering condition is detected by matching the group ID with the list of group IDs.

18. The method of claim 17, wherein each group ID corresponds to an OFDM symbol for SRS transmission.

19. The method of claim 15, wherein the physical layer signaling comprises a number of OFDM symbols for SRS transmission and an offset.

20. The method of claim 19, wherein the triggering condition is detected by matching the group ID plus the offset with the number of OFDM symbols.

21. The method of claim 15, wherein the base station configures multiple group IDs for the UE for aperiodic SRS transmission.
